(19) United States
(12) Patent Application Publication
(10) Pub. No.: US 2012/0256062 A1
(43) Pub. Date: Oct. 11, 2012

(54) METHOD AND APPARATUS FOR SUPPORTING A GREASE GUN

(76) Inventor: Jason Stewart W. HARDY, Houston (CA)

(21) Appl. No.: 13/439,361

(22) Filed: Apr. 4, 2012

Related U.S. Application Data
(60) Provisional application No. 61/516,500, filed on Apr. 5, 2011.

(51) Int. Cl. F16M 13/02; B23P 11/00

(52) U.S. Cl. 248/206.5; 29/525.08

(57) ABSTRACT

A method and apparatus for supporting a grease gun is described. The method involves attaching a barrel of the grease gun to a body having one or more magnetic elements and then magnetically securing the body to a work piece in proximity to a grease nipple using the one or more magnetic elements. The apparatus was developed for use in accordance with the method.

### FIELD

There is described a method and apparatus for supporting a grease gun during use, the apparatus having a secondary function of facilitating storage.

### BACKGROUND

A grease gun generally consists of: a barrel, a hose connected to the barrel, an applicator tip at a remote end of the hose and a lever which is manipulated to pump lubricant from the barrel along the hose to the applicator tip. During use, the grease gun is positioned in close proximity to a grease nipple to which grease is to be applied. The applicator tip of the grease gun is coupled with the grease nipple. The lever of the grease gun is then manipulated to pump lubricant along the hose through the applicator tip and into the grease nipple. What is required is a method and apparatus for supporting the grease gun in order to make it easier to simultaneously control the barrel, the applicator tip and the lever.

### SUMMARY

According to one aspect there is provided a method for supporting a grease gun. The method involves attaching a barrel of the grease gun to a body having one or more magnetic elements and then magnetically securing the body to a work piece in proximity to a grease nipple using the one or more magnetic elements.

According to another aspect there is provided an apparatus for supporting a grease gun, which includes a body, means for securing a barrel of a grease gun to the body, and one or more magnetic element on the body for securing the body to a work piece.

As will hereinafter be further described the foregoing method and apparatus supports and stabilizes the barrel of the grease gun. This enables the user to operate the lever with one hand and control the applicator tip with another hand. It could be said that the apparatus serves as a third hand for the user.

A secondary benefit obtained is the ability to facilitate storage of the grease gun when not required, by magnetically attaching the grease gun to a metal surface, such as the exterior of a tool box.

The description which follows will describe in greater detail an illustrated embodiment. It will be appreciated that there are a number of aspects of the apparatus which could be altered and still have a useful device that will function in accordance with the teachings of the method.

There are different ways of securing the barrel to a supporting body. Beneficial results have been obtained when the body is a sleeve that overlies the barrel of the grease gun. Similarly, there are various ways of securing the barrel of the grease gun to the sleeve. Beneficial results have been obtained through the use of set screws which extend through threaded apertures on the sleeve to clamp the barrel within the sleeve. With this configuration, the grease gun can be placed in any orientation without concern of the grease gun becoming detached from the support, if accidentally bumped.

While the magnetic elements could be attached directly to an exterior surface of a sleeve, it has been found that the magnetic attachment of the sleeve is more versatile when the sleeve has one or more depending feet, with at least one of the one or more magnetic elements positioned at a lower extremity of each of the one or more depending feet. The feet are capable of stepping over irregularities on a surface where the sleeve could not be laid flat.

A hose of a grease gun can get in the way. If it is hanging down, there is danger that it could become pinched, cut or damaged in some way. In order to address that problem, one or more of the depending feet can be provided a hose guide to receive a hose of the grease gun. The hose guide can take a number of forms. It can be as simple as a passage through a depending foot. Regardless of the foam that the hose guide takes, it serves to confine the hose and, thereby, reduce or eliminate damage as a result of the hose hanging down.

There is invariably a residue of grease remaining in the hose of the grease gun after each use. When the grease gun is used in a relatively cold location and then stored in a relatively warm location, the grease will become mobile as it warms and run down the hose. In order to address this problem, a threaded dummy applicator tip coupling is provided. When an applicator tip is coupled with dummy applicator tip coupling, it prevents residue grease in the hose of the grease gun from exiting the applicator tip.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of an apparatus for supporting a grease gun.

FIG. 2 is a perspective view of the apparatus of FIG. 1, in use with a grease gun.

FIG. 3 is a front elevation view, in section, taken along section lines A-A of FIG. 1.

FIG. 4 is a side elevation view, in section, taken along section lines B-B of FIG. 1.

FIG. 5 is a front elevation view, in section, taken along section lines C-C of FIG. 1.

FIG. 6 is a side elevation view, in section, taken along section lines D-D of FIG. 1.

FIG. 7 is a perspective view of the apparatus with grease gun of FIG. 2, in an operative position on a piece of equipment.

FIG. 8 is a perspective view of the apparatus with grease gun of FIG. 2, in a stored position on a tool chest.

### DETAILED DESCRIPTION

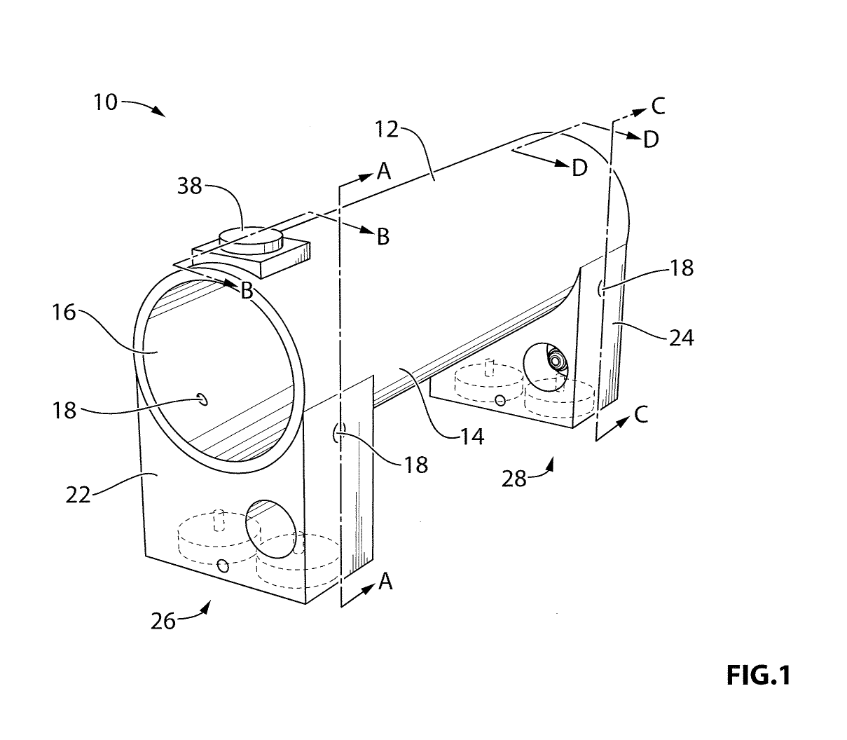

An apparatus for supporting a grease gun generally identified by reference numeral 10, will now be described with reference to FIG. 1 through 8.

### Structure and Relationship of Parts

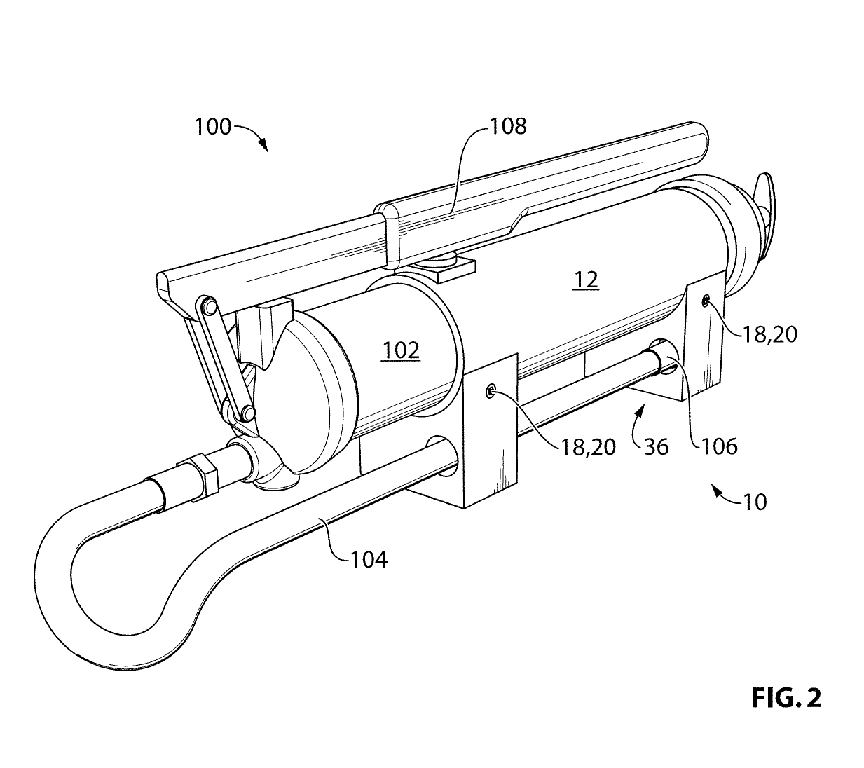

Referring to FIG. 1, apparatus 10 has a sleeve 12. Referring to FIG. 2, when in use, sleeve 12 overlies a barrel 102 of a grease gun 100. Referring to FIG. 1, sleeve 12 has an exterior surface 14 and an interior surface 16. Threaded apertures 18 extend through sleeve 12, from exterior surface 14 to interior surface 16, Referring to FIG. 2, set screws 20 positioned in threaded apertures 18 of sleeve 12, serve to clamp barrel 102 of grease gun 100 within sleeve 12. It will be appreciated that apparatus 10 may have a body other than sleeve 12 and that other means may be used to clamp the barrel of the grease gun within the body. In an earlier proto-type, the body was U-shaped and C-clamps were used to secure the barrel of the grease gun to the U-shaped body.

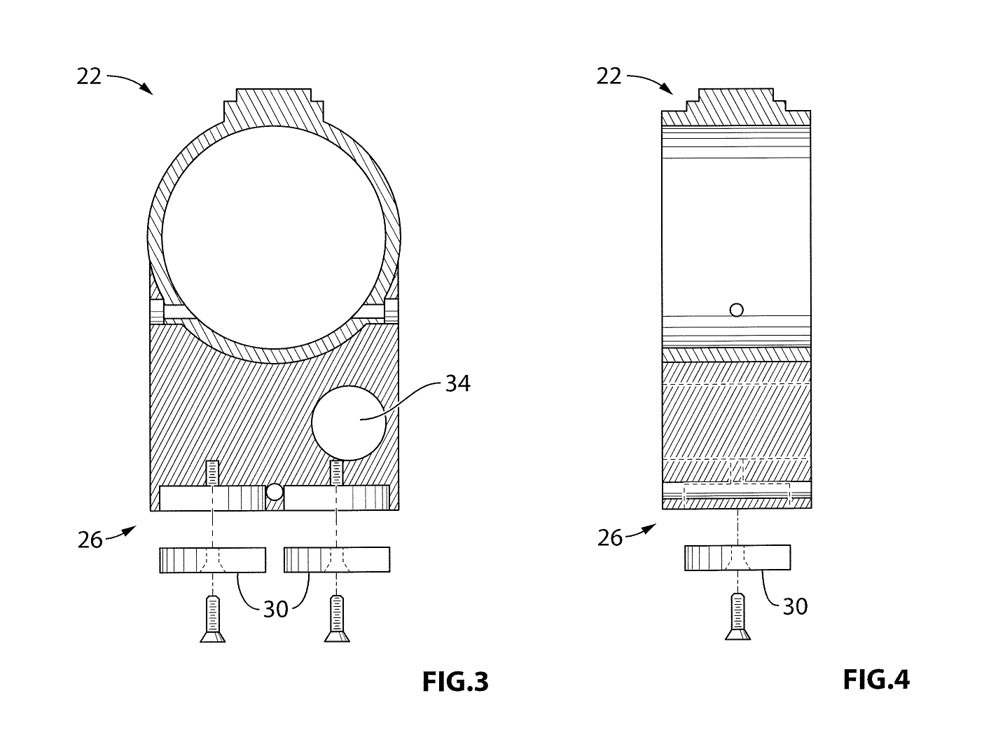

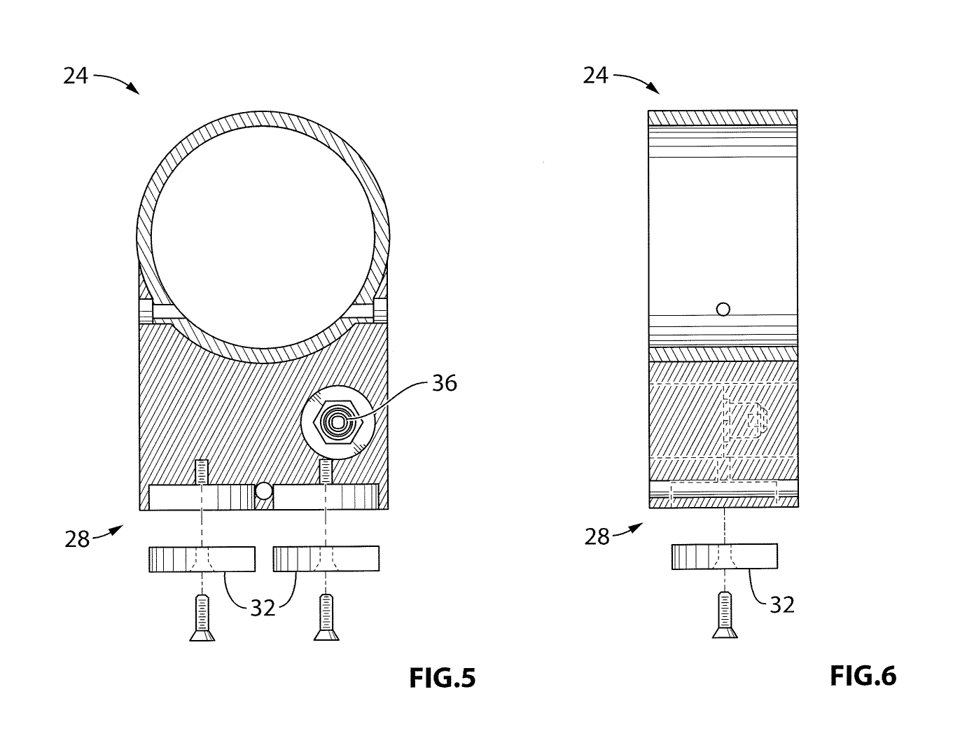

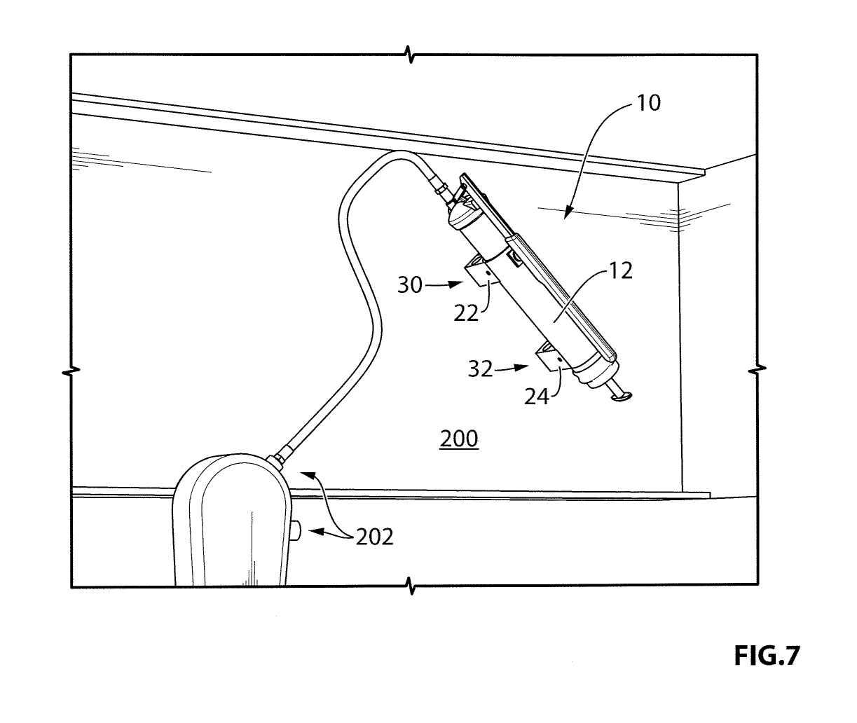

Referring to FIG. 1, a front foot 22 and a rear foot 24 depend from sleeve 12. Each of feet 22 and 24 have a lower extremity; identified as lower extremity 26 and lower extremity 28, respectively. Referring to FIG. 3 and FIG. 4, two magnetic elements 30 are secured to lower extremity 26 of front foot 22. Referring to FIG. 5 and FIG. 6, two magnetic elements 32 are secured to lower extremity 28 of rear foot 24. Referring to FIG. 7, magnetic elements 30 on front foot 22 and magnetic elements 32 on rear foot 24 are used to secure sleeve 12 to a work piece 200.

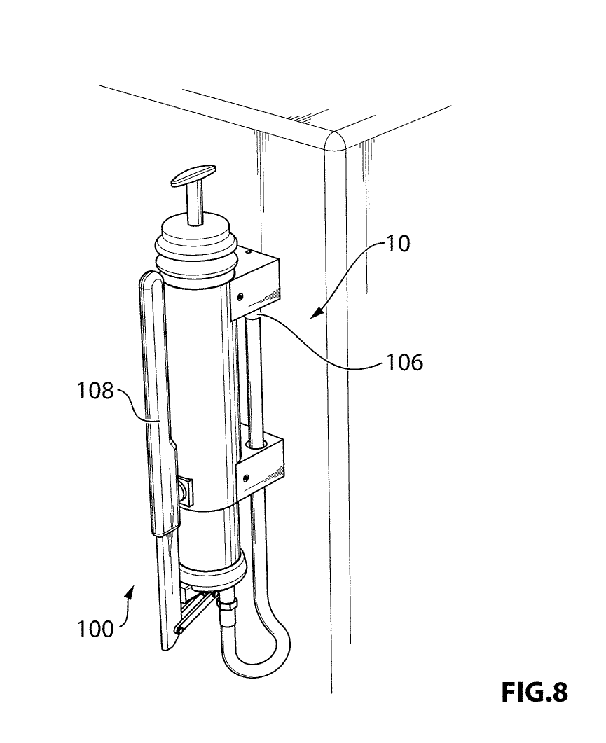

Referring to FIG. 3, front foot 22 has a hose guide in the form of an aperture 34. Referring to FIG, 2, a hose 104 of grease gun 100 extends through aperture 34. Referring to FIG. 5, rear foot 24 has a threaded dummy applicator tip coupling 36. Referring to FIG. 2, when an applicator tip 106 of grease gun 100 is coupled with dummy applicator tip coupling 36, residue grease in hose 104 of grease gun is prevented from exiting applicator tip 106. A typical stored position is illustrated in FIG. 8. Referring to FIG. 1, exterior surface 14 of sleeve 12 has a magnetic engagement 38. Referring to FIGS. 2 and 8, magnetic engagement 38 magnetically secures a lever 108 of grease gun 100 to sleeve 12.

### Operation

Referring to FIG. 2, barrel 102 of grease gun 100 is inserted into sleeve 12 of apparatus 10. Set screws 20 positioned in threaded apertures 18 of sleeve 12, are then used to clamp barrel 102 within sleeve 12. Referring to FIG. 4, hose 104 is extended through aperture 34, which is provided as a hose guide, in front leg 22, in order to reduce the amount of free hose, Referring to FIG. 7, apparatus 10 is magnetically attached to work piece 200 adjacent to grease nipples 202. A piece of heavy equipment has been chosen for illustration as work piece 200. Referring to FIG. 3 and FIG. 5, magnetic elements 30 on front foot 22 and magnetic elements 32 on rear foot 24 are illustrated which enable apparatus to be magnetically secured to work piece 200. Referring to FIG. 7, with apparatus 10 magnetically secured in position, the user has his one hand free to control applicator tip 106 and his other hand free to pump lever 108, causing grease to flow into grease nipples 202.

There are some further features of apparatus 10, which are of benefit when apparatus 10 is stored between uses. Referring to FIG. 8, apparatus 10 is illustrated in a stored orientation. It will be appreciated that movement of lever 108 of grease gun 100 results in grease being pumped out of applicator tip 106. Referring to FIG. 1, FIG. 2 and FIG. 8, magnetic element 38 on exterior surface 14 of sleeve 12 is used for magnetically securing lever 108 of grease gun 100 to sleeve 12. In the absence of magnetic element 38, lever 108 could move by force of gravity. Even a minor movement of lever 108 can cause storage problems. Quite apart from pumping, movement of lever 108 can result in voids being created that fill with air causing air lock. Magnetic element 38 also plays an important role in securing lever 108 during transport. If lever 108 is not secured, vibration experienced during transport can cause an undesirable pumping action. Grease gun 100 is typically used outdoors and then returned to an indoor storage area. As grease gun warms, any grease residue in hose 104 will tend to become mobile. Referring to FIG. 2, FIG. 5 and FIG. 8, applicator tip 106 of grease gun 100 is coupled with dummy applicator tip coupling 36, residue grease in hose 104 of grease gun 100 is prevented from exiting applicator tip 106 during storage.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method for supporting a grease gun, comprising:
attaching a barrel of the grease gun to a body having one or more magnetic elements; and
magnetically securing the body to a work piece in proximity to a grease nipple using the one or more magnetic elements.

2. An apparatus for supporting a grease gun, comprising:
a body;
means for securing a barrel of a grease gun to the body;
one or more magnetic element on the body for securing the body to a work piece.

3. The apparatus of claim 2, wherein the body is a sleeve that overlies the barrel of the grease gun.

4. The apparatus of claim 3, wherein the means of securing the barrel of the grease gun to the sleeve are set screws which extend through threaded apertures on the sleeve to clamp the barrel within the sleeve.

5. The apparatus of claim 3, wherein the sleeve has one or more depending feet, with at least one of the one or more magnetic elements positioned at a lower extremity of each of the one or more depending feet.

6. The apparatus of claim 5, wherein at least one of the depending feet has a hose guide to receive a hose of the grease gun.

7. The apparatus of claim 5, wherein at least one of the depending feet has a threaded dummy applicator tip coupling which, when coupled with an applicator tip prevents residue grease in the hose of the grease gun from exiting the applicator tip.

8. The apparatus of claim 3, wherein the sleeve has an exterior surface with a magnetic engagement for magnetically securing a grease gun lever to the sleeve.

9. An apparatus for supporting a grease gun, comprising:
a sleeve that overlies a barrel of the grease gun, the sleeve having an exterior surface, an interior surface and threaded apertures extending through the sleeve from the exterior surface to the interior surface;
set screws positioned in the threaded apertures of the sleeve, whereby the barrel of the grease gun is clamped within the sleeve;
one or more feet depending from the sleeve, each of the feet having a lower extremity;
one or more magnetic elements on the lower extremity of each of the feet for securing the body to a work piece.

10. The apparatus of claim 9, wherein at least one of the depending feet has a hose guide to receive a hose of the grease gun.

11. The apparatus of claim 9, wherein at least one of the depending feet has a threaded dummy applicator tip coupling which, when coupled with an applicator tip, prevents residue grease in the hose of the grease gun from exiting the applicator tip.

12. The apparatus of claim 9, wherein the sleeve has an exterior surface with a magnetic engagement for magnetically securing a grease gun lever to the sleeve.
